(19) United States
(12) Patent Application Publication
(10) Pub. No.: US 2007/0234888 A1
(43) Pub. Date: Oct. 11, 2007

(54) RHYTHMIC DEVICE FOR THE PRODUCTION, PLAYING, ACCOMPANIMENT AND EVALUATION OF SOUNDS

(75) Inventor: Aurelio Rotolo de Moraes, Curitiba PR (BR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Audiobrax Industria e Comercio de Produtos Eletronicos S/A

(21) Appl. No.: 11/694,287

(22) Filed: Mar. 30, 2007

Related U.S. Application Data
(63) Continuation of application No. PCT/BR05/00209, filed on Oct. 3, 2005.

(51) Int. Cl. G10H 3/14

(52) U.S. Cl. 84/730

(57) ABSTRACT

The present invention provides an rhythmic device associated with vehicle for the production, playing, accompaniment and evaluation of sounds. The device comprises an instrumental karaoke unit which: (i) produce musical instrument sounds from an user's touches; (ii) play music sounds, add musical effects, alter play parameters of the music playing; (iii) mix sounds produced from the user's touches with music sounds played; and (iv) comprises music parameters able to evaluate an instrumental accompaniment performance resulted from the instrumental music sounds produced by the user's touches. The instrumental karaoke unit comprising a surface which comprises: (i) touch sensors spread under said surface providing regions sensitive to touches; and (ii) Leds distributed under said surface and controlled by a microprocessor, Leds providing a luminous indication sequence according to the music sounds played, said luminous indication sequence being following by touches of the user in this surface.

### CROSS-REFERENCE TO RELATED APPLICATIONS

This application is a continuation of International Patent Application No. BR2005/000209, filed Oct. 3, 2005 which designated the United States and was published under PCT Article 21(2) in English and which is hereby incorporated in its entirety by reference.

### BACKGROUND OF THE INVENTION

1. Field of the Invention

This invention refers to an electronic audio device, to be used fastened to the body of a user and inside of a vehicle, since this device can use a vehicle's audio system. It is classified under the “electronics” sector.

2. Description of the State of the Art

The increase in the vehicle fleet and traffic infrastructure deficiencies, especially in big cities, causes constant traffic congestions, forcing the driver and/or passengers to remain in their vehicles for long periods of time. This phenomenon causes distress to the driver and/or passengers, closed-in and isolated in the vehicle, in addition to strengthen the stress caused by day-to-day activities.

While confined in the stopped vehicle, occupants seek to engage in some activity to distract themselves from the real situation, relax and unwind a bit, by listening to music, reading a newspaper or magazine, etc. Despite the music's calming effect on the driver and/or passengers, discontent still remains, reducing their attention to the music.

The present invention's idea is to provide the driver and/or passengers entertaining and pleasurable moments by attenuating their preoccupation, distress and stress. By listening to music and trying to accompany it through a musical instrument (percussion, keyboard, string or blow instrument), the vehicle's occupants pay more attention to what they are doing, also seeking to improve their performance while trying to obtain a good evaluation of their performance. The idea is translated into an electronic device, made preferably to be used strapped to one's body, such electronic device being able to produce, play, multiply, mix sounds and evaluate the user's performance.

The benefits in relation to existing methods are that the user can accompany the song with his hands and/or fingers, as if playing any instrument, and receive a final score at the end of the song, as a way to evaluate their playing success or performance. This serves to further motivate users into seeking to improve their scores and thus, distracting them from the troubles and situations that may disturb them.

### BRIEF SUMMARY OF THE INVENTION

The purpose of this invention is to provide a rhythmic device for the production, playing, accompaniment and evaluation of sounds, such device comprising means to be associated to a vehicle's audio system and assembled in order to be used inside a vehicle.

Another objective of the present invention is to provide a rhythmic device for the production, playing, accompaniment and evaluation of sounds comprising an instrumental karaoke unit where musical instrument sounds from an user's touches are produced, mixed with music sounds played and the results compared to music parameters able to evaluate an instrumental accompaniment performance resulted from said instrumental music sounds produced by the user's touches.

Another objective of the present invention is to provide a rhythmic device for the production, playing, accompaniment and evaluation of sounds comprising an instrumental karaoke unit where musical instrument sounds from an user's touches are produced and sent to an electrical module in order to be mixed with music sounds played and the results compared to music parameters able to evaluate an instrumental accompaniment performance resulted from said instrumental music sounds produced by the user's touches.

It is also an objective of this invention to provide a rhythmic device for the production, playing, accompaniment and evaluation of sounds having the instrumental karaoke unit associated to an electrical module that amplify the resulted sound from the instrumental karaoke unit and send to the vehicle's speakers.

Therefore, the device of this invention is aimed at providing moments of serenity, entertainment, enthusiasm and motivation in situations in which users find themselves confined to their vehicles.

The present invention relates to a rhythmic device for the production, playing, accompaniment and evaluation of sounds, comprising means to be associated to a vehicle's audio system and assembled in order to be used inside a vehicle, said device comprising:

a) an instrumental karaoke unit which: (i) produce musical instrument sounds from an user's touches; (ii) play music sounds, add musical effects, alter play parameters of the music playing; (iii) mix sounds produced from the user's touches with music sounds played; and (iv) comprises music parameters able to evaluate an instrumental accompaniment performance resulted from the instrumental music sounds produced by the user's touches;

b) the instrumental karaoke unit comprising a surface which comprises: (i) touch sensors spread under said surface providing regions sensitive to touches; and (ii) Leds distributed under said surface and controlled by a microprocessor, Leds providing a luminous indication sequence according to the music sounds played, said luminous indication sequence being following by touches of the user in this surface.

The present invention also relates to rhythmic device for the production, playing, accompaniment and evaluation of sounds, comprising means to be associated to a vehicle's audio system and assembled in order to be used inside a vehicle, said device being comprising:

a) an instrumental karaoke unit associated to an electronic module, the electronic module receives digitalized commands from the instrumental karaoke unit, said digitalized commands being results of user's touches provided in a surface of the instrumental karaoke unit;

b) the surface of the instrumental karaoke unit comprising: (i) touch sensors spread under said surface providing regions sensitive to touches; and (ii) Leds distributed under said surface and controlled by a microprocessor, Leds providing a luminous indication sequence according to the music sounds played, said luminous indication sequence being following by touches of the user in this surface; and

c) the electronic module: (i) producing musical instrument sounds from an user's touches; (ii) playing music sounds, adding musical effects, altering play parameters of the music playing; (iii) mixing sounds produced from the user's touches with music sounds played; and (iv) comprising music parameters able to evaluate an instrumental accompaniment performance resulted from the instrumental music sounds produced by the user's touches.

### BRIEF DESCRIPTION OF THE DRAWINGS

This invention will be thereafter described in more details based on an example of execution represented in the drawings. The figures show:

FIG. 1—is a block diagram with the possible elements for the electronic device in reference to its first preferred embodiment, being the object of the present invention;

FIG. 2—is a block diagram representing the first configuration of the electronic device's use in reference to its first preferred embodiment, being the object of the present invention;

FIG. 3—is a block diagram representing the second configuration of the electronic device's use in reference to its first preferred embodiment, being the object of the present invention;

FIG. 4—is a block diagram with all the possible elements for the electronic device in reference to its second preferred embodiment, being the object of the present invention;

FIG. 5—is a block diagram representing the first karaoke unit modality in reference to the first preferred embodiment of the electronic device, being the object of the present invention;

FIG. 6—is a block diagram representing the second karaoke unit modality in reference to the first preferred embodiment of the electronic instrument, being the object of the present invention;

FIG. 7—is a block diagram representing the electronic module in reference to the first preferred embodiment of the electronic device, being the object of the present invention;

FIG. 8—is a block diagram representing the third karaoke unit modality in reference to the second preferred embodiment of the electronic device, being the object of the present invention;

FIG. 9—is a block diagram representing the fourth karaoke unit modality in reference to the second preferred embodiment of the electronic device, being the object of the present invention;

FIG. 10—is a block diagram representing the electronic module in reference to the second preferred embodiment of the electronic device, being the object of the present invention;

FIG. 11—is a block diagram of the command unit, being the object of the present invention;

FIG. 12—views of the frontal face, upper side and lower side of the first modality of the karaoke unit, in reference to the first preferred embodiment of the electronic device object of the present invention;

FIG. 13—views of the front face, upper side, lower side, right side and left side of the second modality of the karaoke unit, in reference to the first preferred embodiment of the electronic device object of the present invention;

FIG. 14—views of the frontal face, upper side and lower side of the third modality of the karaoke unit, in reference to the second preferred embodiment of the electronic device, object of the present invention;

FIG. 15—is a view of the front face of the command unit, being the object of the present invention;

FIG. 16—views of the front face, upper side and lower side of the fourth modality of the karaoke unit, in reference to the second preferred embodiment of the electronic device object of the present invention;

FIG. 17—is a spatial view of the first modality of the karaoke unit fastened to its adjustable elastic strap, in reference to the first preferred embodiment of the electronic device object of the present invention;

FIG. 18—is a spatial view of the electronic module, in reference to the first preferred embodiment of the electronic device object of the present invention;

FIG. 19—is a spatial view of the electronic module, in reference to the second preferred embodiment of the electronic device object of the present invention;

FIG. 20—is a spatial view of the second modality of the karaoke unit fastened to its adjustable elastic strap, in reference to the first preferred embodiment of the electronic device object of the present invention;

FIG. 21—is a spatial view of the third modality of the karaoke unit fastened to its adjustable elastic strap, in reference to the second preferred embodiment of the electronic device object of the present invention;

FIG. 22—is a spatial view of the fourth modality of the karaoke unit fastened to its adjustable elastic strap, in reference to the second preferred embodiment of the electronic device object of the present invention; and

FIG. 23—is a spatial view of the command unit, being the object of the present invention.

### DETAILED DESCRIPTION OF THE INVENTION

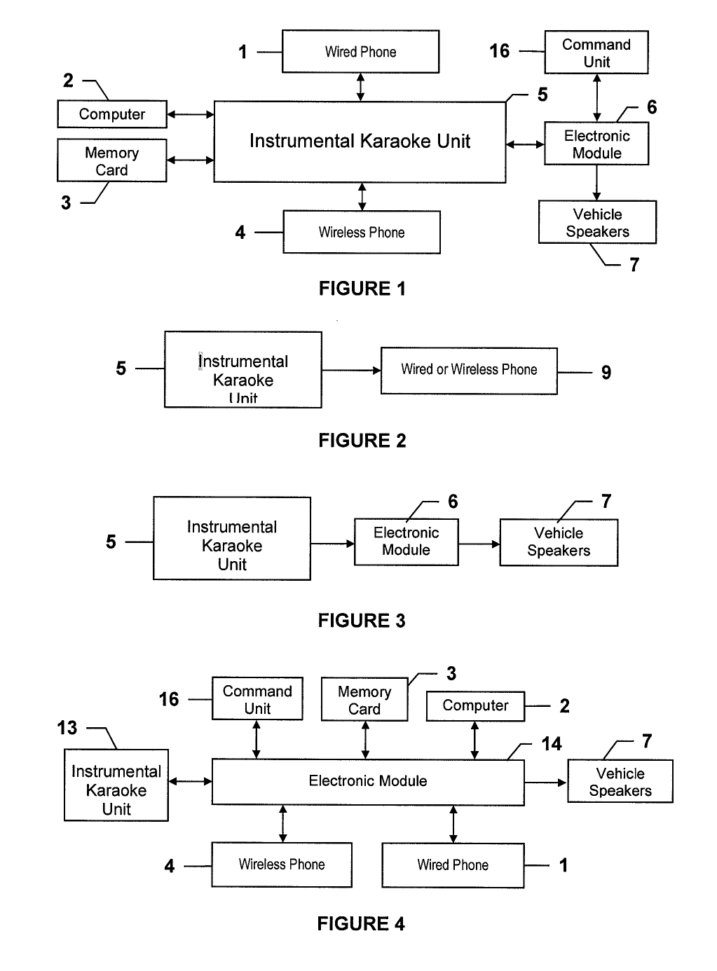

The block diagram of FIG. 1 represent, in summary, the first preferred embodiment of the electronic device object of the present invention. All use possibilities and possible connections are indicated. This embodiment of the device is made up by the following elements:—Instrumental karaoke unit 5;—Electronic module 6; and—Command unit 16. Other accessories complement the device's functionalities, such as wired earphone 1, wireless earphone 4, computer 2 and memory card 3.

The device has two functioning options. The first option, shown on FIG. 2, includes the karaoke unit 5 sending processed sounds to a wireless or wired earphone 9. In the second option, illustrated by FIG. 3, the instrumental karaoke unit 5 sends a processed sound to an electronic module 6, which decodes the received sound and amplifies it for the vehicle's speakers system output 7. For this two cases, it is also accepted the use of the command unit 16 as a means of visualizing information or running commands in the instrumental karaoke unit 5 or electronic module 6.

The second preferred embodiment for the electronic device of the present invention, as illustrated by the block diagram of FIG. 4, comprises the following elements:—Instrumental karaoke unit 13;—Command unit 16; and—Electronic module 14. In this embodiment, the instrumental karaoke unit 13, the electronic module 14, the command unit 16 and the vehicle's speakers 7 make up the essential configuration for the device's functioning while the wireless earphone 4, wired earphone 1, computer 2 and memory card 3 represent accessories for the purposes of complementing the device's functionalities.

The main difference of the second preferred embodiment of the device, in relation to the first one, is that the instrumental karaoke unit 13 sends commands to the electronic module 14 which, in its turn, runs these commands resulting in a processed sound, which is sent to the vehicle's speakers 7. Therefore, the electronic module 14 acts as a processing unit, implementing most part of the device's functionalities. Only the instrumental karaoke unit 13 and the electronic module 14 are different from the ones assigned for the first preferred embodiment.

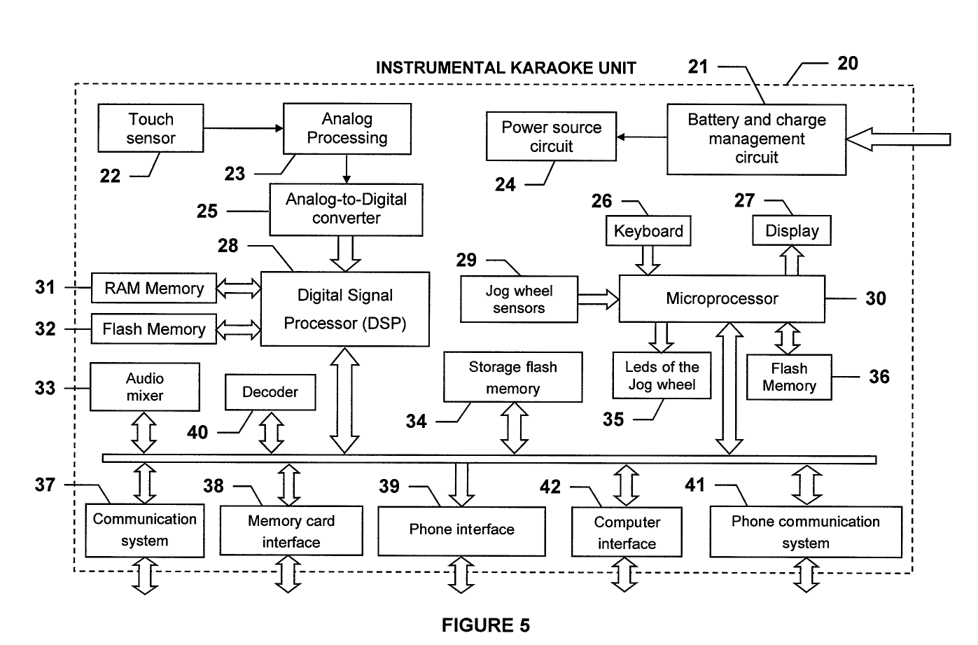

FIG. 5 presents the detailed block diagram of the first modality of the instrumental karaoke unit 20 in reference to the first preferred embodiment of the device object of the present invention. This instrumental karaoke unit is equipped with analogical and digital electronic circuits which, in association with the software installed, constitute a system able to produce musical instrument sounds (percussion, keyboard, string or blow instruments), play music, add musical effects, alter play parameters of the music playing, mix sounds and evaluate the ability of the instrumental and/or vocal accompaniment performance of the user, who directly or indirectly acts in all of the functionalities.

The instrumental karaoke unit 20 is powered by an internal battery, rechargeable, which along with the battery and charge management circuit 21, allows the user to recharge the battery when required. A power source circuit 24 provides regulated electric voltage to power the remaining circuits.

The Jog disk 193 surface has a touch sensor 22, which detects beats/touches by the hand and/or fingers of the user, sensitive to frequency and intensity. The touch sensor 22 can be a piezoelectric transducer, field effect, or a pressure, force, vibration or acceleration sensor as well. Many touch sensors may be spread out over the jog disk 193 to provide different regions sensitive to touch, for which can be spread out distinct functionalities to each one. With this sensor multiplicity in the jog disk 193, the user can, for instance, act on various commands, or produce instrumental and/or different musical note sounds, change parameters or concurrently insert different effects or not, into the playing music.

The resulting analogical signals from the sensor, or sensors, pass through an analogical processing circuit 23, which amplifies and sets its response, in where the resulting signals are converted into digital words through an analog-to-digital converter 25. The digital words resulting from the conversion are sent to the digital signal processor or DSP 28, which carries out the entire digital sound, signal and communications processing associated to this device. The DSP 28 uses two types of memory:—RAM memory 31, which temporarily stores data and;—Flash memory 32, which contains the software from the said firmware system, digital synthesized sounds, samples, sound effects and other essential data for the unit's functioning.

DSP 28 also accesses files and/or data from the storage flash memory 34, being responsible for music playing, instrumental sounds production (percussion, keyboard, string or blow instruments), alteration of play parameters, sound mixing, addition of sound effects (echo, delay, pitch, distortions, etc.), interpretation and execution of files for instrumental karaoke, as well as provide the user's performance evaluation from these files, among other attributes.

When the files are for music or instrumental karaoke, and require decoding or decompacting, the DSP 28 uses the decoder 40 to run such task. In addition, the DSP 28 can access the files contained in the memory card 3, through the memory card interface 38. The audio mixer 33 has the task of mixing two or more sounds when required, in reference to music, music instruments sounds and sound effects, resulting in a single sound. The mixed or resulting sound is sent to the communication system 37, earphone interface 39 and wireless communication system for phone 41.

The computer interface 42 provides a means of connection with a computer in order to update firmware, or even add, or exclude stored flash memory 34 data, or memory card 3 data, through the memory card interface 38. It is important to point out that the computer interface 42 is compatible with most wired communication ports or wireless communication systems used in PCs.

The communication system 37 is intended to send the resulting sound to the electronic module 6, receive information from this module, send information to the command unit 16, and receive commands from it as well. This communication should be bi-directional (two-way) and can be achieved by radio frequency, ultrasound, infrared light or electric wiring/cabling, as well as an association of two or more of these means of communication.

The earphone interface 39 converts the resulting digital sound into proper analogical sounds to excite the wired earphones.

The earphones communication system 41 has the objective to send and/or receive sounds from a remote system composed of earphones without using wires in the process. This communication system is compatible with any wireless earphone set, as the wireless earphones are accessories of the electronic device of this invention.

The microprocessor 30 processes user interface devices such as display 27, keyboard 26 and Jog disk 193, as well as controls the remaining system components, working along with the DSP 28. The display 27 shows the user the instrument's operational status, menus, functions, charts and other visual information. The keyboard 26 works as a command input, gathering user press-keys. The microprocessor 30 has a specific flash memory 36, which contains the firmware that defines its functionalities and all operations that this device can execute. Jog disk sensors 29, which have the purpose of detecting the velocity and angular position of the disk, provide digital signals which are sent to the microprocessor 30, and which run the respective local processing, sending them to the DSP 28 in the form of commands.

The Leds (light emitting diodes) of the Jog disk 35 are distributed in suitable form below the Jog disk 193 surface and are controlled by the microprocessor 30. The function of these leds is to provide luminous indication to the user in reference to action that need to be taken, that is, inform the user the disk spot that should be touched as well as the moment and intensity of the respective touch. The illuminated region or point on the surface of the disk corresponds to the touch point and the luminous intensity, which is controllable, and is related to the force or pressure to be applied. The combination of these leds also provides luminous indication in the form of arrows, circles, squares, and other geometric shapes, in addition to figures and symbols to indicate functionalities, functions, commands and, aid and improve the use of the device.

An important characteristic of the Jog disk 193 is that its surface is composed of a soft rubber or cushioned material, which is semitransparent or transparent to light, allowing the luminosity of the leds 35, placed below the surface, to be properly seen by the user. For example, when a future action is of the type “rotate disk clockwise at maximum intensity”, a group of leds arranged in arrow form should light up in a sequence in reference to the rotation and the intensity, and will inform the velocity to be applied. Thus, the user notices the rotation's direction and how fast he should rotate, observing the speed of the arrow formation and its luminous intensity. Another reason for the disk surface to be soft is to prevent hand and/or finger injury due to repetitive touches/impacts.

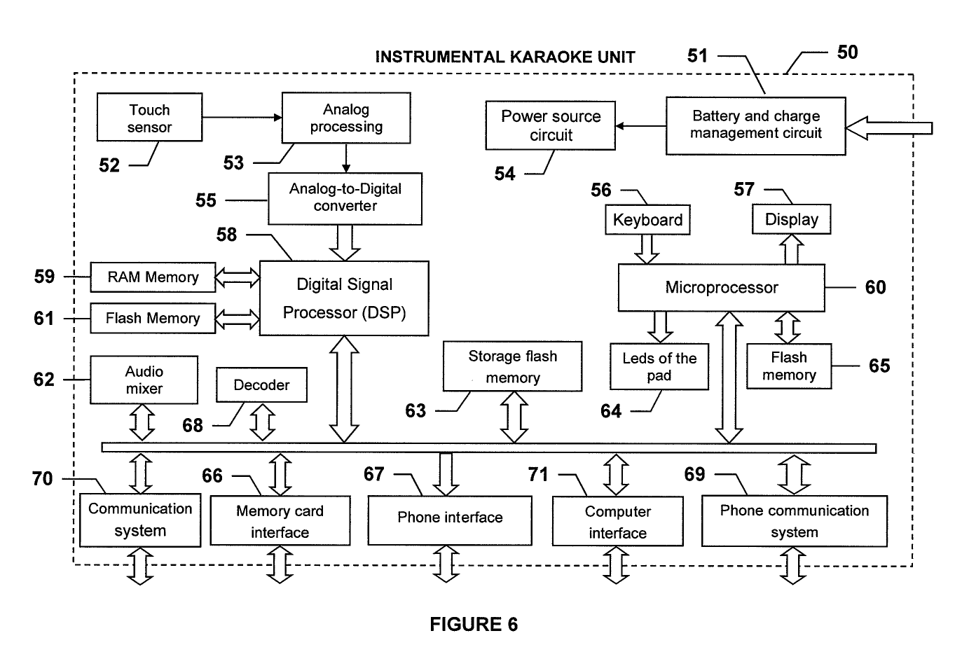

The FIG. 6 presents the detailed block diagram of the second modality of the instrumental karaoke unit 50 in reference to the first preferred embodiment of the device object of the present invention. This second modality is distinguished from the first because of its use a touch sensitive pad or surface 239 instead of a Jog disk 193. Thus, the block diagram of FIG. 6 is identical to the FIG. 5 one, except that it excludes the Jog disk sensors 29 and makes reference to the leds, formerly in the jog disk, as pad leds 64. It is important to point out that the functionalities of the first modality of the instrumental karaoke unit 20 are maintained, but differently created for this second modality, also in reference to the first preferred embodiment.

The pad 239 has several touch sensors 52 associated to its surface regions or points, as well as leds 64 distributed under this surface to indicate functionalities, functions, commands and also assist and improve the use of the device. In this case, to simulate the rotation of the Jog disk 193, the user should slide or drag his hand over the pad 239. The speed, movement direction and intensity are detected by the sensors in place and converted in rotation direction and speed equivalent to the Jog disk 193.

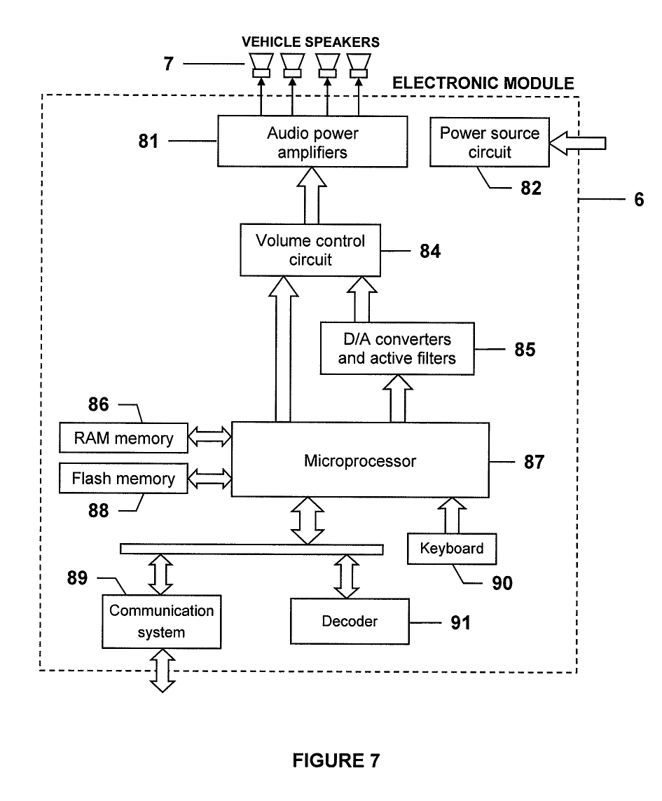

The FIG. 7 presents block diagram of the electronic module 6, in reference to the first preferred embodiment, being the object of this invention. This module has the objective of receiving the resulting sound in the form of data from the instrumental karaoke unit 50, 20, 5, decode these data, convert them into analogical signals and amplify the resulting signal in order to actuate the vehicle's speakers 7.

The electronic module 6 is fed by the vehicle's battery, and its power source circuit 82 provides the necessary voltages for it to function. The data sent by the communication system 89 of the instrumental karaoke unit 50, 20, 5 are received by the communication system 89 of the electronic module 6, decoded by a decoder 91 and processed, if necessary, by a microprocessor 87. This microprocessor 87 uses two types of memory:—RAM memory 86, which stores data temporarily; and Flash memory 88, which stores system firmware and other functionalities. The on/off key 333 and indicator led 332 are associated to the keyboard circuit 90. The decoded and processed data are sent from the microprocessor 87 to the analogical-digital converter and active filters 85, producing the analogical signals corresponding to the digital data received, that is, the resulting sound sent by the instrumental karaoke unit 50, 20, 5 is recomposed in the electronic module 6. The normalized output signal of the D/A converter and active filters 85 then passes through a volume control circuit 84, which sets the amplitude of this signal. Finally, the adjusted signal is amplified by the audio power amplifiers 81 for direct output through the vehicle's speakers 7.

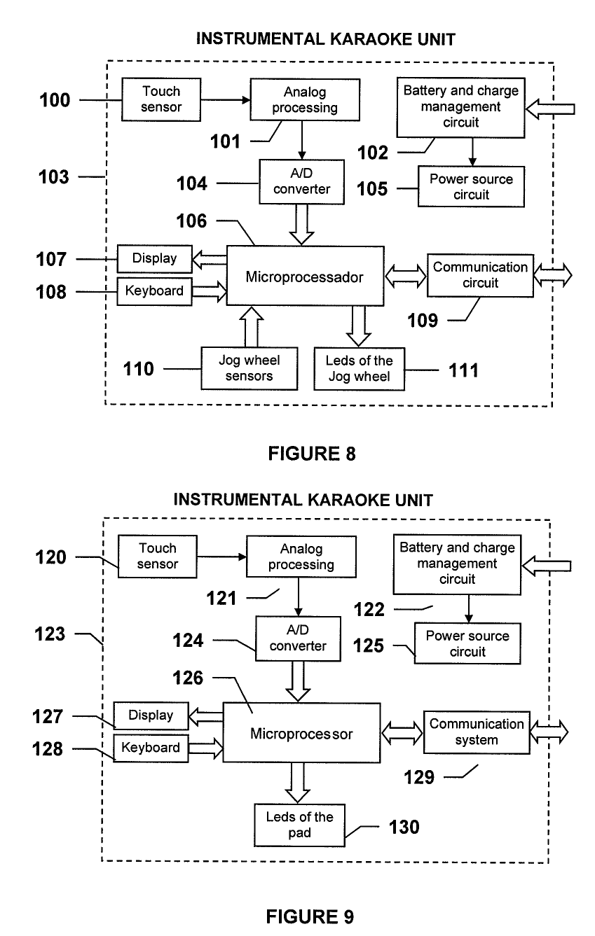

The FIG. 8 presents the block diagram of the third modality of the instrumental karaoke unit 103 in reference to the second preferred embodiment of the device object of the present invention. This unit is equipped with an internal battery rechargeable and a battery and charge management circuit 102, where the power source circuit 105 is responsible for the supply of regulated voltage to the remaining circuits.

The Jog disk 193 has at least one touch sensor 100, which detects beats/touches by the hand and/or fingers of the user, being sensitive to frequency and intensity. The touch sensor 100 can be a piezoelectric transducer, field effect, or even a pressure, force, vibration or acceleration sensor. The signals of this sensor pass through an analog processing circuit 101 in order to condition the sensor signals, sending the resulting signals to an A/D converter 104, which converts the analogical signals into words for the microprocessor 106 to process.

Many touch sensors can be spread out over the jog disk 193 to provide different touch-sensitive regions, assigning distinct functionalities for each one.

The sensors of the Jog disk 110, which have the purpose of detecting the rotating speed and angular position of the disk, provide digital signs, which are sent to the microprocessor 106. The processing of the keyboard 108, which involves all karaoke unit keys 103, it is also made by the microprocessor 106, which also sends information to the display 107.

The commands and controls executed by the user are processed by the microprocessor 106 and sent by means of the communication system 109 to the electronic module 6. In the same way, specific information on the song, musical effects, files, among others, are sent to the karaoke unit 103. This communication system 109 can use radio frequency, ultrasound, infrared light or electric wiring/cabling, as well as associate two or more of these means of communication.

The leds of the Jog disk 111 are distributed in suitable form on the surface of the Jog disk 193 and are controlled by the microprocessor 106. In the same manner as in the first modality of the karaoke unit 103, in reference to the first preferred embodiment of the device, the function of these leds is to provide luminous indication to the user in reference to the action that needs to be taken, that is, inform the user the disk spot that should be touched, as well as the moment and intensity of the respective touch.

The fourth and last modality of the karaoke unit 123 in reference to the second preferred embodiment of the device is much more detailed on the block diagram of FIG. 9. This unit is distinguished from the third modality because of a pad 239 in place of the jog disk 193 and the led sod the pad 130 being distributed on the pad's surface 239.

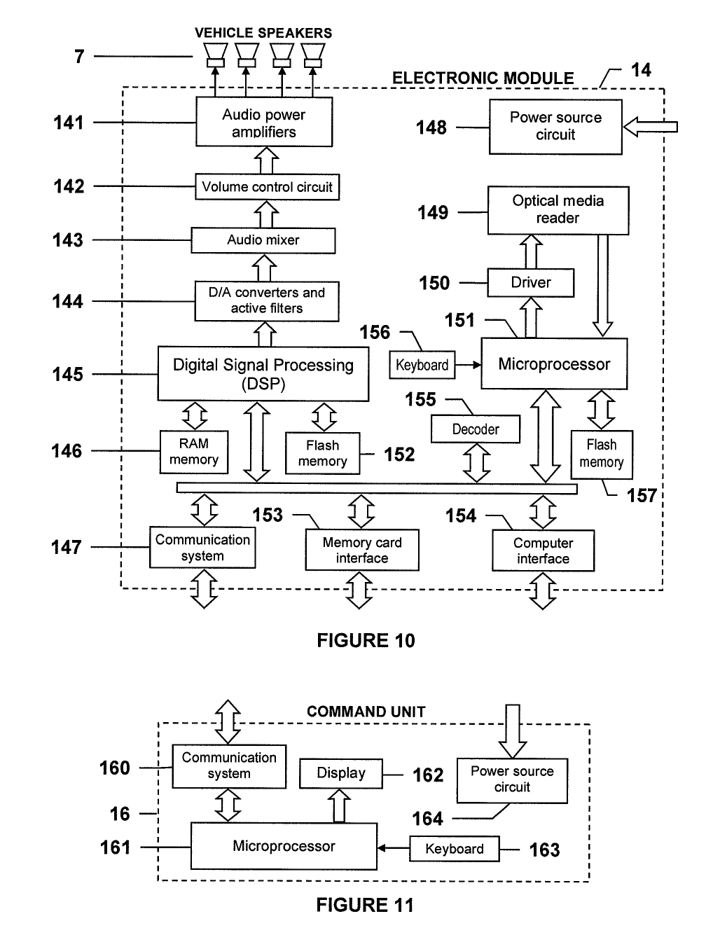

FIG. 10 presents the block diagram of the electronic module 14, in reference to the second preferred embodiment of the device object of this invention. The objective of this module is to receive commands from the instrumental karaoke unit 13, 103 123, decode them, produce sounds, effects, play songs, mix two or more sounds (specifically a mix of instrumental sounds and effects sounds in the music modified or not), amplify the resulting sound for output through the vehicle's speakers 7, plus evaluating user's performance. The power supply of the electronic module 14 comes from the vehicle's battery, being the power source circuit 148 what supplies the regulated voltage for all devices of this device.

The communication system 147, similar and compatible with the communication system of the instrumental karaoke unit 13, 103, 123, receives commands from this unit and sends them to the microprocessor 151, which interprets these commands and executes them. The microprocessor 151 receives commands from the keyboard 156, controls the optical media reader 149, through the driver 150, and receives its data, processing them locally and passing them to the DSP 145. The Flash memory 157 of the microprocessor 151 stores the firmware of the system and customized information.

The DSP 145 is responsible for music playing, instrumental sounds production (percussion, keyboard, string or blow instruments), alteration of play parameters, sound mixing, addition of sound effects (echo, delay, speed, distortions, etc.), interpretation and execution of files for instrumental karaoke sounds, as well as user performance evaluation from these files, among other attributes. In addition, the DSP 145 can access data (songs, files, samples, patterns instrumental karaoke, etc) contained in the memory card 3, through the interface for memory card 153. To decode data such as songs and samples, the DSP 145 makes use of a decoder 155.

The DSP 145 uses two types of memory:—RAM memory 146, which temporarily stores data and;—Flash memory 152, which contains firmware, instrumental music sounds, samples, effects and codes for the unit's functioning as required.

A computer interface 154 provides a means of communication with a computer, in order to update firmware, or even, add or exclude stored flash memory data in the memory card data 3. This interface is compatible with most communication ports with wire or wireless communication systems used in PCs.

The sounds originating from the DSP 145 are converted into analogical signals by means of D/A converters and active filters 144. Several audio channels are made available and can be mixed by the audio mixer 143. Thus, the sound of one or more songs can be mixed with the sound of one musical instrument and/or sound effect, for instance. The sound resulting from the mixer is adjusted in amplitude by the volume control circuit 142, entering into the audio amplifiers 141, which deliver the necessary power for vehicle's speakers 7.

The FIG. 11 presents the block diagram of the command unit 16, which acts with the electronic module 6, 14, being compatible with the first and second preferred embodiment of the device. This unit preferably connects with the electronic module 6, 14 to provide additional control for the device by its keyboard 163, and to present additional information on its display 162. The energy to supply this unit can come from the vehicle's battery or directly through the electronic module 6, 14, where the power source circuit 164 provides the regulated voltages required for the supply of the remaining circuits of the unit.

The microprocessor 161 acts in the processing of received and sent data as well as controlling of the remaining devices of the command unit 16. The communication system 160 is equal and compatible to the electronic module's communication system 89, 147 and to the instrumental karaoke unit 37, 70, 109, 129, establishing data's communication with any of these components. Therefore, the communication system 160 communicates in two-way direction and can use radio frequency, ultrasound, infrared light or electric wiring/cabling, as well as associate two or more of these means of communication.

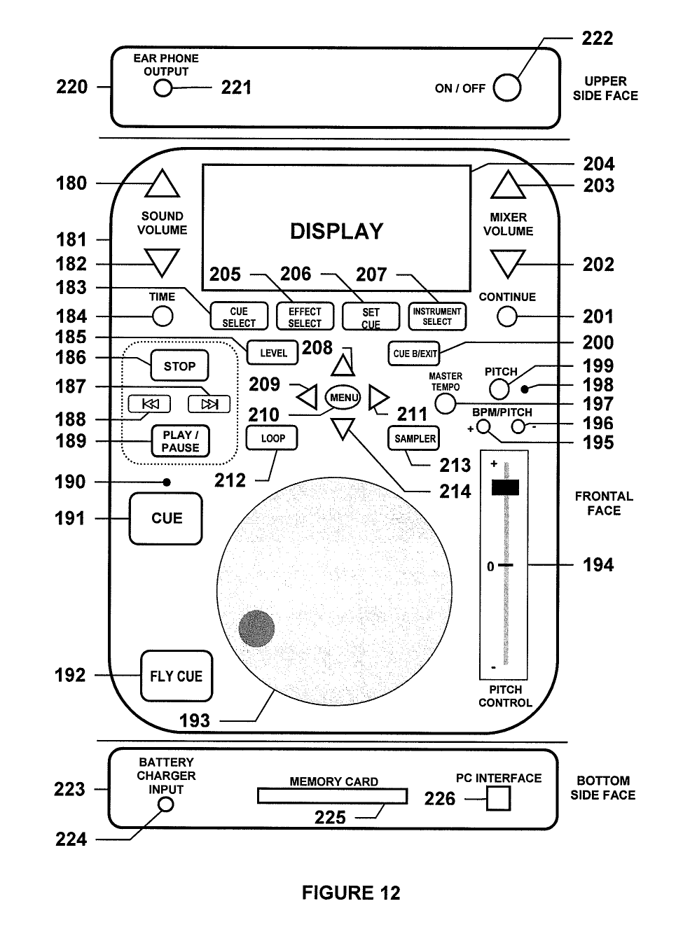

The FIG. 12 shows the front face 181, upper side 220 and lower side 223 of the first modality of the instrumental karaoke unit 20, in reference to the first preferred embodiment of this invention. On the upper side 220 there is the connector for the wired earphone 221 and a button to turn the unit on/off 222. The lower side 223 has the connector for the entry of the battery charger 224, memory card entry 225 and computer connector 226.

The main controls, commands and display 204 are on the frontal face 181. The graphic display 204 allows the user to see menus and sub menus, name of songs, play list, volume settings, graphic equalizer, battery meter, communication monitors, accompaniment signals, diverse texts and different icons as well as visualize applications graphic interfaces.

The volume of the musical instruments (percussion, keyboards, string or blow instruments) or intensity of sound effects mixed into the song can be adjusted by the sound volume keys 182, 180. The master volume, which corresponds to sounds mixed with the song, can be adjusted by the mixer's volume keys 202, 203.

The TIME key 184 has the function of changing the play display mode of playtime, which can be altered, to show remaining or played time. The CONTINUE key 201 activates the repeat function, which takes place when playing ends, starting it again from the beginning of the list. The basic music control functions are in the following keys: STOP 186, which cancels play; Fast-Forward/Next-music 187, which fast forwards the playing track or jumps to the next track; Fast-Rewind/Previous-music 188, which rewinds the playing track or plays the previous track and; PLAY/PAUSE 189, which begins playing the music selected or pauses it. From MENU key 210 and browsing keys 214, 209, 211, 208 it is possible to access the system submenu menus, activate application and function keys in general.

The Jog disk 193 allows for different functions for the device functioning. This spinning disk simulates a conventional turntable, although it does not spin by itself, but it can act on the sound effects attributed to the playing music. By spinning the jog disk 193 clockwise, a function or command is progressively actuated, and spinning it anticlockwise, regressive actuation of the function or command is achieved. The speed at which the disk is spun by the hand and/or finger of the user is also taken into consideration. In addition, the jog disk 193 is sensitive to touch/beat by a hand and/or fingers, and can be used in the accompaniment of a song, for example.

By acting as DJ, the user has different functions and resources. One of these resources is the cue function responsible for marking a spot to begin playing a song. It is therefore necessary to pause the song by pressing PLAY/PAUSE 189, set the exact point by spinning the Jog disk 193, and pressing the CUE key 191. The led 190 will flash during the selection and will stay on when a point has been memorized. When the user wishes to return to the memorized point, he/she just needs to press the CUE key again 191. Another similar function is given by the FLY CUE key 192, which marks a point on the song playing, allowing the song to be restarted from the point marked by the CUE key 191. Different play spots can be memorized through the SET CUE key 206 and can be selected using the CUE SELECT key 183.

Another important function of the instrument is the music play speed setting (or pitch function). Through the PITCH key 199, the speed is selected, which can be done through the BPM/PITCH keys 195, 196, the sliding control 194 or Jog disk 193. While the pitch function is activated the led 198 stays on. The BPM/PITCH keys 195, 196 have the second function of defining or showing the number of beats per minute (bass and sudden tons) in the music. A speed level can be set through the pitch function and pressing the MASTER TEMPO key 197, where the speed will be considered as normal play speed.

A period of the song can be marked to play constantly or mixed into the music. By marking the initial point using the CUE 191 or FLY CUE keys 192, and the final point using the CUE B/EXIT key 200, the user can continuously (or in loop) play when pressing the LOOP key 212 or mix this period into the music, making use of the SAMPLER key 213. To exit these functions it is necessary to press the CUE B/EXIT key 200, returning to the normal music play mode.

The instrumental karaoke unit 5, 20, 50 can produce several musical instruments sounds, such as percussion instruments, keyboards, string instruments or blow instruments, being selected through the INSTRUMENT SELECT key 207. Once a given instrument is selected, to produce its sounds, just beat the jog disk 193 surface with the user's hand or fingers. The intensity of the beat will influence the instrument's sound intensity or its musical note. In addition, sound effects can be produced, such as: scratching, echo, frequency filters, play delay, stop or gradual play, in addition to different types of distortions in the music on play. Selection of the type of effect is done through the EFFECT SELECT key 205.

Through the LEVEL key 185 it is possible to set the difficulty level of the performance evaluation for the user in four levels: beginner w/help, easy, medium and difficult.

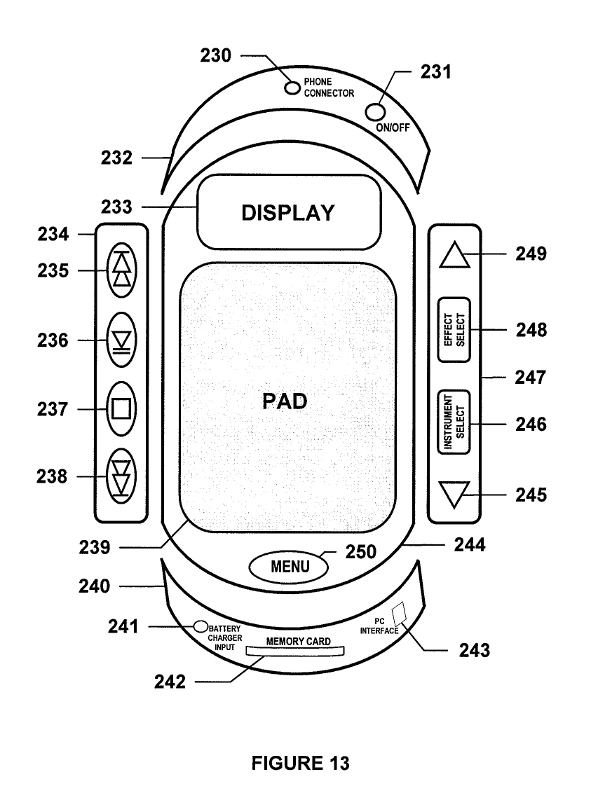

FIG. 13 shows the front face 244, right side 247, left side 234, upper side 232 and lower side 240 of the second modality of the instrumental karaoke unit 50, in reference to the first preferred embodiment.

On the upper side 232 there is the connector for the earphone 230 and a button to turn the unit on/off 231. The lower side 140 has the battery charger connector 241, memory card entry 242 and computer interface connector 243.

The music play control keys are on the left side 234, which include the Stop key 237, Play/Pause 236, Fast-Forward/Next-music 238 and Fast-Rewind/Previous-music 235. On the right side 247 there are the keys for INSTRUMENT SELECT 246, for musical instrument selection (percussion, keyboard, string or blow), EFFECT SELECT 248, for sound effect selection, and two arrows 249, 245 to change the selected parameter value.

The front face 244 has a graphic display 233, the pad 239 and the MENU key 250, which activates and controls the menus shown on the display 233. The pad 239 can also be used to command, used in the menu selection movement of menus and activate the selected function.

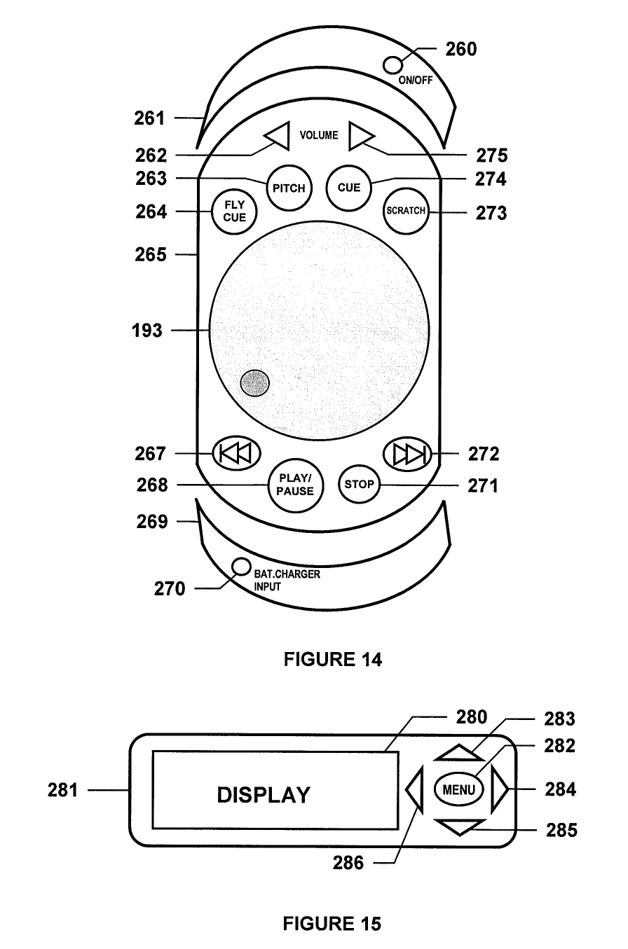

FIG. 14 shows the front face 265, upper side 261 and lower side 269 of the third modality of the instrumental karaoke unit 103, in reference to the second preferred embodiment of the device object of this invention. The upper side 261 has an on/off button for the unit 260, while the lower side 269 has a battery charger connector 270.

On the front face 265 there are the jog disk 193 and the control keys. The play control keys include the STOP key 271, PLAY/PAUSE 268, Fast-Forward/Next-music 272 and Fast-Rewind/Previous-music 267. The commonest DJ functions are represented by the FLY CUE 264, PITCH 263, CUE 274 and SCRATCH keys 273. The resulting sound volume can be adjusted by the volume arrows 275, 262.

The functionalities of the second preferred embodiment are complemented with the use of the command unit 16, where the front face 281 is shown in detail on FIG. 15. This unit can be fixed to the vehicle's panel surface, on one of the windows, on the center of the steering wheel or on the most adequate surface for the user to see the information displayed 280 and easily operate the keys. The menus can be activated by pressing the MENU key 282, while the browsing keys 284, 285, 286, 283 assist in the selection of options offered by the menus.

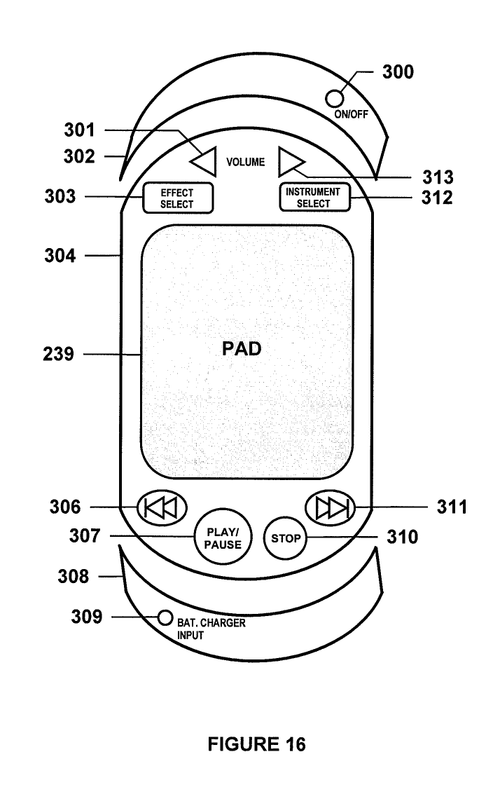

FIG. 16 shows the front face 304, upper side 302 and lower side 308 of the fourth modality of the karaoke unit 123, in reference to the first preferred embodiment of this device. The upper side 302 has an on/off button for the unit 300, while the lower side 308 has a connector to charge the internal battery 309.

The pad 239 and control keys are located on the front face 304. The play control keys are: STOP 310, PLAY/PAUSE 307, Fast-Forward/Next-music 311 and Fast-Rewind/Previous-music 306. The EFFECT SELECT key 303 allows the selection of sound effects and DJ functions, while the INSTRUMENT SELECT key 312 selects musical instruments (percussion, keyboard, string or blow). The master or resulting sound volume can be adjusted by the volume arrows 313, 301. The pad 239 can also be used in the selection of functions and assist in browsing through the menus.

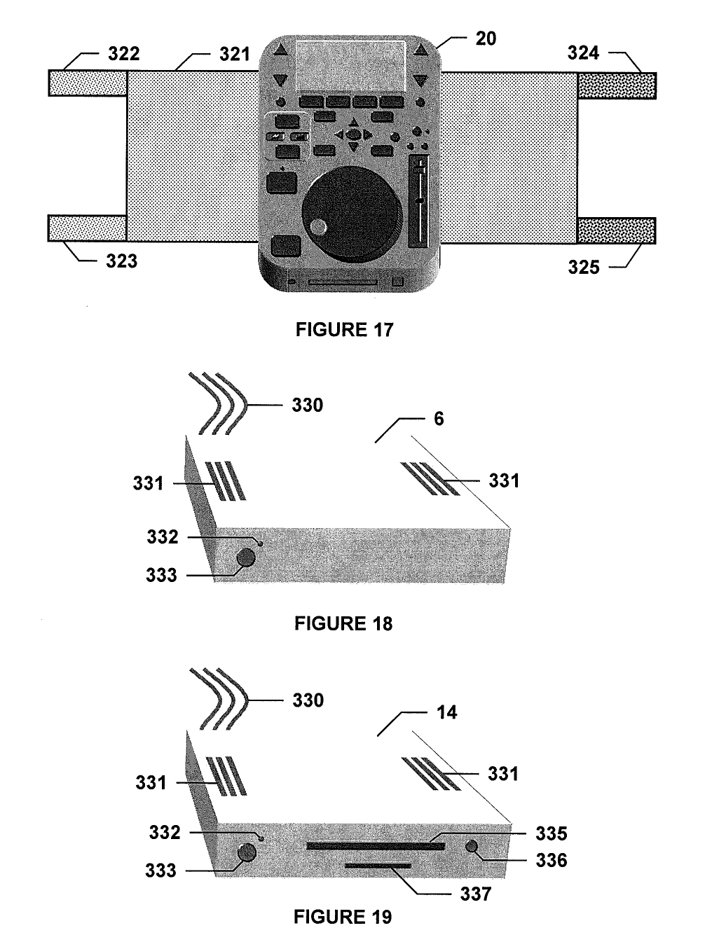

FIG. 17 shows a spatial vision of the first modality of the instrumental karaoke unit 20, which is strapped by an elastic and adjustable belt 231. This belt has straps or adhesive portions, or Velcro®, 322, 323, 325, 324, which help in fastening and adjusting this device to the body of the user.

The electronic module 6, in reference to the first preferred embodiment of the device, is presented in a spatial view on FIG. 18. This module has ventilation inlets 331 on its surface and electrical wires/cables 330 leave through the back to provide supply connections and with the vehicle's speakers 7. The module's on/off button 333 is on the front face along with the power led 332.

FIG. 19 shows a spatial view of the electronic module 14, in reference to the second preferred embodiment of the device of this invention. This module has ventilation inlets 331 on its surface and electrical wires/cables 330 leave through the back to provide supply connections and with the vehicle's speakers 7. On the front face there is an optical media entry 335, an optical media ejection button 336, a memory card entry 337, an on/off button 333 for this module and a power led 332.

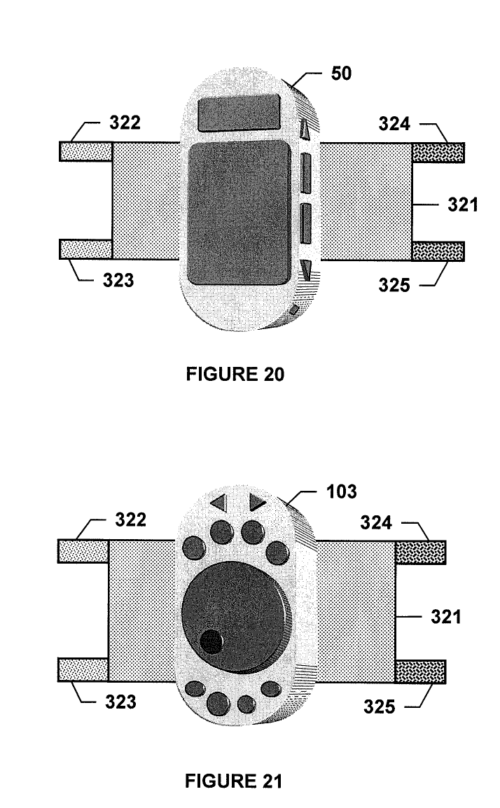

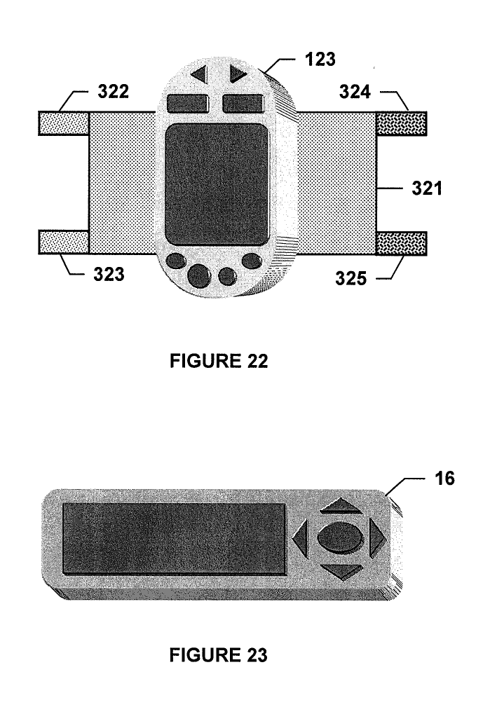

The second modality of the instrumental karaoke unit 50 is seen in perspective on FIG. 20. This unit is fastened to its adjustable elastic belt 321. FIG. 21 shows a spatial view of the third modality of the instrumental karaoke unit 103, which is strapped by an adjustable elastic belt 321. The fourth and final modality of the instrumental karaoke unit 123 is seen in perspective on FIG. 22, to which is fastened its adjustable elastic belt 321.

The adjustable elastic belt 321, present on all instrumental karaoke unit modalities 20, 50, 103, 123, has straps or adhesive parts, or Velcro®, 322, 323, 325, 324 that allow for safely and correctly ergometric positioning on the user's body. FIG. 23 shows a spatial view of the command unit 16, which can be fastened, glued, or stuck to a surface inside the vehicle.

Considering the four modalities for the instrumental karaoke unit 5, 13, 20, 50, 103, 123, they are composed of a box with display, keys and contact surface (pad or jog disk), internally equipped with printed circuit boards, electronic components, communication modules, rechargeable batteries, connecting wires, mechanical supports and other elements to compose the electronic and mechanical structure. In the same form, the electronic module 6, 14 of both preferred embodiments is composed of a box or casing that shelters the printed circuits with electronic components, optical media reader, memory card socket, electrical wires/cables, mechanical parts, among others.

The device of this invention also offers applications to the user, such as: games, agenda, calendar, play list editor, sound settings, advanced configurations, file editor, contact list, alarm clock and clock. These applications are preferably found in the instrumental karaoke unit 5, 13, 20, 50, 103, 123, particularly in its firmware.

Considering both the pad 239 and the jog disk 193, we point out that the surface is composed of a soft rubber or cushioned material, which is semitransparent or transparent to light, to allow the luminosity of the leds placed below the surface to be properly seen by the user.

The user interacts with the instrumental karaoke unit 5, 13, 20, 50, 103, 123, through the available controls to run the instrumental of a song or apply sound effects to it, and, by the end of the song, the user receives a score corresponding to his performance. In the case of accompaniment of instrumental or use of sound effects, the evaluation considers the synchronism, touch intensity, jog disk 193 movement, musical instruments used, instrumental notes used and types of effects during the activity. Through the Jog disk 193 and incorporated functions of the instrumental karaoke unit 5, 13, 20, 50, 103, 123, the user can assume the role of a DJ, having his DJ abilities evaluated. The reference standards for the evaluated parameters are in the file that composes the song or in a specific instrumental karaoke file. These parameters are used for the calculation of the score, in reference to the user's performance, which is shown on the graphic display 204, 233, 280.

The difficulty level has the function of establishing a given rigor in the user's performance evaluation. They are divided into four levels: beginner w/help, easy, medium and difficult. To such end, the evaluation parameters receive different weights and different standards are selected according to the defined level.

1. Rhythmic device for the production, playing, accompaniment and evaluation of sounds, comprising means to be associated to a vehicle's audio system and assembled in order to be used inside a vehicle, said device being characterized in that comprises:
a) an instrumental karaoke unit (5, 20, 50) which: (i) produce musical instrument sounds from an user's touches; (ii) play music sounds, add musical effects, alter play parameters of the music playing; (iii) mix sounds produced from the user's touches with music sounds played; and (iv) comprises music parameters able to evaluate an instrumental accompaniment performance resulted from the instrumental music sounds produced by the user's touches;
b) the instrumental karaoke unit (5, 20, 50) comprising a surface which comprises: (i) touch sensors (22, 52) spread under said surface providing regions sensitive to touches; and (ii) Leds (34, 64) distributed under said surface and controlled by a microprocessor, Leds (34, 64) providing a luminous indication sequence according to the music sounds played, said luminous indication sequence being following by touches of the user in this surface.

2. Rhythmic device, according to claim 1, characterized in that the surface of the instrumental karaoke unit (5, 20, 50) comprises a Jog disk (193) sensitive to frequency and intensity of the user's touches in operation with the touch sensors (22).

3. Rhythmic device, according to claim 2, characterized in that the surface of the instrumental karaoke unit (5, 20, 50) comprises a multiplicity of touch sensors (22) forming different regions sensitive to the user's touches, said regions comprising distinct functionalities.

4. Rhythmic device, according to claim 1, characterized in that the surface of the instrumental karaoke unit (5, 20, 50) comprises a pad (239) sensitive to frequency and intensity of the user's touches in operation with the touch sensors (52).

5. Rhythmic device, according to claim 4, characterized in that the surface of the instrumental karaoke unit (5, 20, 50) comprises a multiplicity of touch sensors (52) forming different regions sensitive to the user's touches, said regions comprising distinct functionalities.

6. Rhythmic device, according to claim 3, characterized in that the touch sensors (22, 52) have the function of detecting beats/touches by the hand and/or fingers of the user.

7. Rhythmic device, according to claim 3, characterized in that the touch sensors (22, 52) are piezoelectric transducers, field effect or pressure sensors, force, vibration or acceleration sensors.

8. Rhythmic device, according to claim 7, characterized in that the touch sensors (22, 52) produce signals that are processed by an analog processing circuit (23, 53), converted by an analogical-digital converter (25, 55) and sent to a digital signal processor (28, 58), said digital signal processor (28, 58) being able to access storage music parameters in order to compare said parameters with the signals from the touch sensors (22, 52) processed and produced by the user's touch.

9. Rhythmic device, according to claim 8, characterized in that the evaluation of the sounds produced by the user's touch compared with the storage music parameters is made by the digital signal processor (28, 58).

10. Rhythmic device, according to claim 9, characterized in that comprises means to visualize information and running commands associated to the instrumental karaoke unit (5, 20, 50), said means to visualize information and commands consisting of an command unit (16).

11. Rhythmic device, according to claim 10, characterized in that in the evaluation of sounds produced by the user's touch compared with the storage music parameters made by the digital signal processor (28, 58) the instrumental karaoke unit (5, 20, 50) produces an evaluation that is visualized in the command unit (16).

12. Rhythmic device, according to claim 11, characterized in that the evaluation of sounds produced by the user's touch compared with the storage music parameters is made according to evaluation's criterions consisting on synchronism, touch's intensity, movement of the Jog disc (193), music instrument used and sounds effect used.

13. Rhythmic devICE, according to claim 1, characterized in that the Jog disc (193) and the pad (239) are made having a surface composed of a soft rubber or cushioned material, semitransparent or transparent to light.

14. Rhythmic device, according to claim 1, characterized in that the Leds (35, 64) are configured in order to have a combination of these Leds (35, 64) providing luminous indication in symbols and geometric shapes indicating functions of the device.

15. Rhythmic device, according to claim 1, characterized in that comprises an adjustable elastic belt (321) associated to the instrumental karaoke unit (5, 20, 50), the adjustable elastic belt (321) comprising adhesive portions (322, 323, 324, 325) able to fast the instrumental karaoke unit (5, 20, 50) to the user's body.

16. Rhythmic device, according to claim 1, characterized in that comprises wireless earphone (1) and wire earphone (4) associated to the instrumental karaoke unit (5, 20, 50).

17. Rhythmic device, according to claim 1, characterized in that the instrumental karaoke unit (5, 20, 50) send resulting sounds to the wireless earphone (1) and to the wire earphone (4) through an earphone interface (39) positioned in the instrumental karaoke unit (5, 20, 50).

18. Rhythmic device, according to claim 1, characterized in that comprises a computer (2) and a memory card (3) associated to the instrumental karaoke unit (5, 20, 50).

19. Rhythmic device, according to claim 18, characterized in that the instrumental karaoke unit (5, 20, 50) reads or writes data into the memory card (3) through a memory card interface (38, 66) positioned in the instrumental karaoke unit (5, 20, 50).

20. Rhythmic device, according to claim 19, characterized in that the instrumental karaoke unit (5, 20, 50) play a music contained in the memory card (3).

21. Rhythmic device, according to claim 18, characterized in that the instrumental karaoke unit (5, 20, 50) establishes communication with the computer (2) through a computer communication interface (42, 71).

22. Rhythmic device, according to claim 21, characterized in that the instrumental karaoke unit (5, 20, 50) stores data from a computer.

23. Rhythmic device, according to claim 22, characterized in that the instrumental karaoke unit (5, 20, 50) makes available data for a computer.

24. Rhythmic device, according to claim 1, characterized in that the instrumental karaoke unit (5, 20, 50) comprises a internal storage memory (34, 63), said instrumental karaoke unit (5, 20, 50) being able to play a music from the internal storage memory (34, 63).

25. Rhythmic device, according to claim 24, characterized in that the instrumental karaoke unit (5, 20, 50) mixes a sound of a musical instrument or a sound effect with a music sounds from the internal storage memory (34, 63) or from the memory card (3).

26. Rhythmic device, according to claim 24, characterized in that the instrumental karaoke unit (5, 20, 50) mixes a sound of a modified music with a sound effect from the internal storage memory (34, 63) or from the memory card (3).

27. Rhythmic device, according to claim 1, characterized in that the instrumental karaoke unit (5, 20, 50) is associable to a electronic module (6) which receives mixed sounds from the instrumental karaoke unit (5, 20, 50) and amplifies said mixed sounds for a vehicle speakers (7).

28. Rhythmic device, according to claim 27, characterized in that commands and controls executed by the user are processed by the digital signal processor (28, 58) and mixed sounds are sent to the electronic module (6) through a communication system (37, 70).

29. Rhythmic device, according to claim 28, characterized in that data are sent by the communication system (37, 70, 89) through radio frequency.

30. Rhythmic device, according to claim 28, characterized in that data are sent by the communication system (37, 70, 89) through ultrasound.

31. Rhythmic device, according to claim 28, characterized in that data are sent by the communication system (37, 70, 89) through infrared light.

32. Rhythmic device, according to claim 28, characterized in that data are sent by the communication system (37, 70, 89) through electric wires or cables.

33. Rhythmic device for the production, playing, accompaniment and evaluation of sounds, comprising means to be associated to a vehicle's audio system and assembled in order to be used inside a vehicle, said device being characterized in that comprises:
a) an instrumental karaoke unit (13, 103, 123) associated to an electronic module (14), the electronic module (14) receives digitalized commands from the instrumental karaoke unit (13, 103, 123), said digitalized commands being results of user's touches provided in a surface of the instrumental karaoke unit (13, 103, 123);
b) the surface of the instrumental karaoke unit (13, 103, 123) comprising: (i) touch sensors (100, 120) spread under said surface providing regions sensitive to touches; and (ii) Leds (111, 130) distributed under said surface and controlled by a microprocessor, Leds (111, 130) providing a luminous indication sequence according to the music sounds played, said luminous indication sequence being following by touches of the user in this surface; and
c) the electronic module (14): (i) producing musical instrument sounds from an user's touches; (ii) playing music sounds, adding musical effects, altering play parameters of the music playing; (iii) mixing sounds produced from the user's touches with music sounds played; and (iv) comprising music parameters able to evaluate an instrumental accompaniment performance resulted from the instrumental music sounds produced by the user's touches.

34. Rhythmic device, according to claim 33, characterized in that the surface of the instrumental karaoke unit (13, 103, 123) comprises a Jog disk (193) sensitive to frequency and intensity of the user's touches in operation with the touch sensors (100).

35. Rhythmic device, according to claim 34, characterized in that the surface of the instrumental karaoke unit (13, 103, 123) comprises a multiplicity of touch sensors (100) forming different regions sensitive to the user's touches, said regions comprising distinct functionalities.

36. Rhythmic device, according to claim 33, characterized in that the surface of the instrumental karaoke unit (13, 103, 123) comprises a pad (239) sensitive to frequency and intensity of the user's touches in operation with the touch sensors (120).

37. Rhythmic device, according to claim 36, characterized in that the surface of the instrumental karaoke unit (13, 103, 123) comprises a multiplicity of touch sensors (120) forming different regions sensitive to the user's touches, said regions comprising distinct functionalities.

38. Rhythmic device, according to claim 35, characterized in that the touch sensors (100, 120) have the function of detecting beats/touches by the hand and/or fingers of the user.

39. Rhythmic device, according to claim 35, characterized in that the touch sensors (100, 120) are piezoelectric transducers, field effect or a pressure sensors, force, vibration or acceleration sensors.

40. Rhythmic device, according to claim 38, characterized in that the touch sensors (100, 120) produce signals that are processed by an analog processing circuit (101, 121), converted by an analogical-digital converter (104, 124), processed by a microprocessor (106, 126) resulting commands that are sent to the electronic module (14) where said commands are read by a digital signal processor (145), said digital signal processor (145) being able to access storage music parameters in order to compare said parameters with the signals from the touch sensors (100, 120) processed and produced by the user's touch.

41. Rhythmic device, according to claim 40, characterized in that the evaluation of the sounds produced by the user's touch compared with the storage music parameters is made by the digital signal processor (145).

42. Rhythmic device, according to claim 41, characterized in that comprises means to visualize information and running commands associated to the electronic module (14), said means to visualize information and commands consisting of an command unit (16).

43. Rhythmic device, according to claim 42, characterized in that in the evaluation of sounds produced by the user's touch compared with the storage music parameters made by the digital signal processor (145) the electronic module (14) produces an evaluation that is visualized in the command unit (16).

44. Rhythmic device, according to claim 43, characterized in that the evaluation of sounds produced by the user's touch compared with the storage music parameters is made according to evaluation's criterions consisting on synchronism, touch's intensity, movement of the Jog disc (193), music instrument used and sounds effect used.

45. Rhythmic device, according to claim 33, characterized in that the Jog disc (193) and the pad (239) are made having a surface composed of a soft rubber or cushioned material, semitransparent or transparent to light.

46. Rhythmic device, according to claim 33, characterized in that the Leds (111, 130) are configured in order to have a combination of these Leds (111, 130) providing luminous indication in symbols and geometric shapes indicating functions of the device.

47. RHYTHMIC DEVICE, according to claim 33, characterized in that comprises an adjustable elastic belt (321) associated to the instrumental karaoke unit (13, 103, 123), the adjustable elastic belt (321) comprising adhesive portions (322, 323, 324, 325) able to fast the instrumental karaoke unit (13, 103, 123) to the user's body.

48. Rhythmic device, according to claim 33, characterized in that comprises a computer (2) and a memory card (3) associated to the electronic module (14).

49. Rhythmic device, according to claim 48, characterized in that the electronic module (14) reads or writes data into the memory card (3) through a memory card interface (153) positioned in the electronic module (14).

50. Rhythmic device, according to claim 48, characterized in that the electronic module (14) plays a music contained in the memory card (3).

51. Rhythmic device, according to claim 50, characterized in that the electronic module (14) establishes communication with the computer (2) through a computer communication interface (154).

52. Rhythmic device, according to claim 51, characterized in that the electronic module (14) stores data from a computer.

53. Rhythmic device, according to claim 52, characterized in that the electronic module (14) makes available data for a computer.

54. Rhythmic device, according to claim 33, characterized in that the electronic module (14) comprises an optical media reader (149), said electronic module (14) being able to play a music from a memory card (3).

55. Rhythmic device, according to claim 54, characterized in that the electronic module (14) mixes a sound of a musical instrument or a sound effect with a music sounds from the memory card (3).

56. Rhythmic device, according to claim 55, characterized in that the electronic module (14) mixes a sound of a modified music with a sound effect from the memory card (3).

57. Rhythmic device, according to claim 33, characterized in that the instrumental karaoke unit (13, 103, 123) is associable to the electronic module (14) through a communication system (109, 129, 147).

58. Rhythmic device, according to claim 57, characterized in that data are sent by the communication system (109, 129, 147) through radio frequency.

59. Rhythmic device, according to claim 57, characterized in that data are sent by the communication system (109, 129, 147) through ultrasound.

60. Rhythmic device, according to claim 57, characterized in that data are sent by the communication system (109, 129, 147) through infrared light.

61. Rhythmic device, according to claim 57, characterized in that data are sent by the communication system (109, 129, 147) through electric wires or cables.
